(19) United States
(12) Patent Application Publication
(10) Pub. No.: US 2020/0104043 A1
(43) Pub. Date: Apr. 2, 2020

(54) HEAD MOUNTED DISPLAY DEVICE AND CONTENT INPUT METHOD THEREOF

(71) Applicant: SHENZHEN ROYOLE TECHNOLOGIES CO. LTD., Shenzhen (CN)

(72) Inventor: Zheng HUANG, Shenzhen (CN)

(21) Appl. No.: 16/471,266

(22) PCT Filed: Dec. 24, 2016
(86) PCT No.: PCT/CN2016/111869

§ 371 Date: Jun. 19, 2019

(51) Int. Cl. G06F 3/0488; G06F 3/041; G06F 3/01; G06F 3/0481

(52) U.S. Cl. CPC G06F 3/04886; G06F 3/04817; G06F 3/018; G06F 3/041

(57) ABSTRACT

A head mounted display device includes a display apparatus and a touch input apparatus. A content input method includes: controlling the display apparatus to display a soft keyboard input interface (T1) in response to a content input request, where, the soft keyboard input interface includes a first soft keyboard (J1) and a second soft keyboard (J2); when a touch operation is input on a first touch area, a target key on the first soft keyboard is determined according to a mapping relationship between touch operations and keys on the soft keyboard; and a corresponding key value for triggering the determined target key is further determined; when a touch operation is input on a second touch area, a target key on the second soft keyboard is determined according to a mapping relationship; and a corresponding key value for triggering the determined target key is further determined.

### RELATED APPLICATION

The present application is a National Phase of International Application Number PCT/CN2016/111869, filed Dec. 24, 2016.

### TECHNICAL FIELD

The present disclosure relates to a display device, and in particular, to a head mounted display device and a content input method thereof.

### BACKGROUND

At present, the head mounted display device has been gradually popularized by people for its convenience, stereoscopic display and stereo effects. In recent years, with the advent of virtual reality (VR) technology, the head mounted display device has become more widely configured as a hardware support device for VR technology. Since the user cannot see outside environment after wearing the head mounted display device, therefore, inputting content by using exist input apparatus is often inconvenient.

### SUMMARY

The embodiments of the present disclosure disclose a head mounted display device and a content inputting thereof, which can facilitate user input of content.

The head mounted display device disclosed in embodiments of the present disclosure includes a display apparatus, a touch input apparatus and a processor. The touch input apparatus is configured to detect touch operations; the touch input apparatus includes a first touch area and a second touch area. The processor is configured to control the display apparatus to display a soft keyboard input interface in response to a content input request. The soft keyboard input interface includes a first soft keyboard and a second soft keyboard. The first soft keyboard and the second soft keyboard each includes a plurality of keys. The first touch area corresponds to the first soft keyboard, and the second touch area corresponds to the second soft keyboard. When a touch operation is input on the first touch area, the processor determines a target key on the first soft keyboard corresponding to the touch operation according to a mapping relationship between touch operations and keys on the soft keyboard, and further triggers a key value corresponding to the target key on the first soft keyboard. When a touch operation is input on the second touch area, the processor determines a target key on the second soft keyboard corresponding to the touch operation according to a mapping relationship between touch operations and keys on the soft keyboard, and further triggers a key value corresponding to the target key on the second soft keyboard.

The content input method disclosed in the embodiments of the present disclosure is applied to a head mounted display device. The head mounted display device includes a display apparatus and a touch input apparatus. The touch input apparatus includes a first touch area and a second touch area. The method includes the steps of: the display apparatus is controlled to display a soft keyboard input interface in response to a content input request, wherein, the soft keyboard input interface includes a first soft keyboard and a second soft keyboard, and the first soft keyboard and the second soft keyboard each includes a plurality of keys; when a touch operation is input on the first touch area, a target key on the first soft keyboard corresponding to the touch operation is determined according to a mapping relationship between touch operations and keys on the soft keyboard, and a key value corresponding to the target key on the first soft keyboard is triggered; when a touch operation is input on the second touch area, a target key on the second soft keyboard corresponding to the touch operation is determined according to a mapping relationship between touch operations and keys on the soft keyboard, and a key value corresponding to the target key on the second soft keyboard is triggered.

The head mounted display device and the content input method thereof of the present disclosure can be configured for conveniently inputting character content after the user wears the head mounted display device.

### BRIEF DESCRIPTION OF THE ACCOMPANYING DRAWINGS

In order to more clearly illustrate the technical solutions in the embodiments of the present disclosure, the drawings to be used in the embodiments will be briefly described below. It is obvious that the drawings in the following description are only some embodiments of the present disclosure. Those skilled in the art can also obtain other drawings based on these drawings without paying any creative work.

FIG. 1 is a schematic diagram of a head mounted display device according to one embodiment of the present disclosure.

FIG. 2 is a block diagram of a head mounted display device according to one embodiment of the present disclosure.

FIG. 3 is a schematic diagram of a soft keyboard input interface displayed by a display apparatus of a head mounted display device according to one embodiment of the present disclosure.

FIG. 4 is a schematic diagram of a touch input apparatus of a head mounted display device according to one embodiment of the present disclosure.

FIGS. 5 to 6 are schematic diagrams showing an input process of a soft keyboard input interface in an English input mode according to one embodiment of the present disclosure.

FIGS. 7 to 9 are schematic diagrams showing an input process of a soft keyboard input interface in a Chinese input mode according to one embodiment of the present disclosure.

FIG. 10 is a schematic diagram of a mapping relationship between touch operations and keys of the soft keyboard according to one embodiment of the present disclosure.

FIG. 11 is a schematic diagram of an input box displayed by the display apparatus according to one embodiment of the present disclosure.

FIG. 12 is a flowchart of a content input method according to one embodiment of the present disclosure.

FIG. 13 is a sub-flowchart of step S121 of FIG. 12 in one embodiment.

FIG. 14 is a sub-flowchart of step S127 of FIG. 12 in one embodiment.

FIG. 15 is a sub-flowchart of step S127 of FIG. 12 in another embodiment.

### DETAILED DESCRIPTION OF ILLUSTRATED EMBODIMENTS

The technical solutions in the embodiments of the present disclosure are clearly and completely described in the following with reference to the accompanying drawings in the embodiments of the present disclosure. It is obvious that the described embodiments are only a part of the embodiments of the present disclosure, and not all of the embodiments. All other embodiments obtained by those skilled in the art based on the embodiments of the present disclosure without creative efforts are within the scope of the present disclosure.

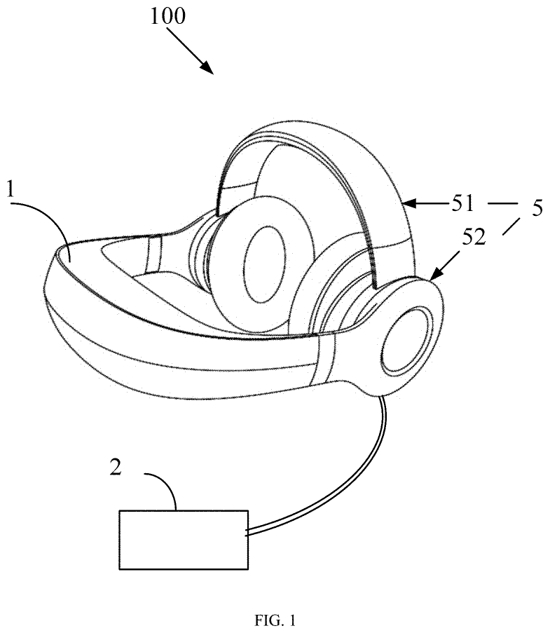

Please referring to FIG. 1, a schematic diagram of a head mounted display device 100 according to one embodiment of the present disclosure is illustrated. The head mounted display apparatus 100 includes a display apparatus 1 for outputting display images.

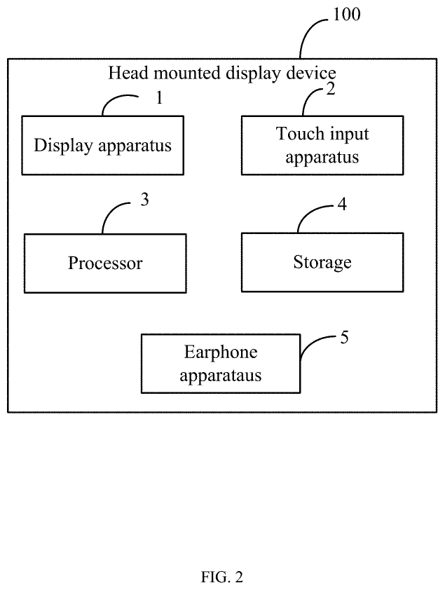

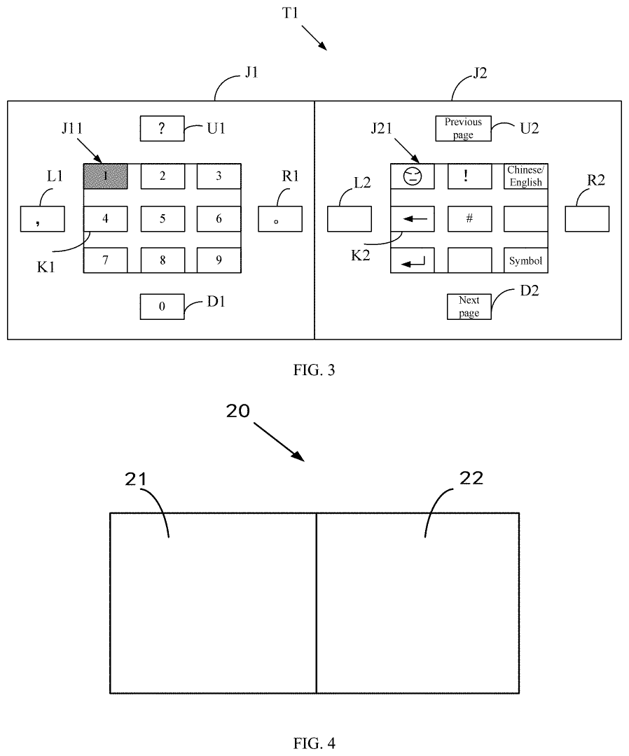

Please referring to FIG. 2 and FIG. 3 together, FIG. 2 is a block diagram of the head mounted display device 100. The head mounted display device 100 includes a touch input apparatus 2 and a processor 3 in addition to the display apparatus 1.

The touch input apparatus 2 includes at least one touch area. The at least one touch area is configured for detecting touch operations. The touch operation can be configured to input a content input request. The processor 3 is configured to control the display apparatus 1 to display a soft keyboard input interface T1 as shown in FIG. 3 in response to the content input request. The soft keyboard input interface T1 includes at least one soft keyboard. When a touch operation is input on at least one touch area, the processor 3 determines a target key corresponding to the touch operation according to a mapping relationship between touch operations and keys on the soft keyboard, and triggers a key value corresponding to the target key.

Referring to FIG. 4 together, the touch input apparatus 2 includes a first touch area 21 and a second touch area 22. As shown in FIG. 3, the soft keyboard input interface T1 includes a first soft keyboard J1 and a second soft keyboard J2. The first soft keyboard J1 includes a plurality of keys K1, and the second soft keyboard J2 includes a plurality of keys K2.

The first touch area 21 corresponds to the first soft keyboard J1, and the second touch area 22 corresponds to the second soft keyboard J2. When a touch operation is input on the touch input apparatus 2, the processor 3 determines a touch area where the touch operation is input. When the touch operation is input on the first touch area 21, the processor 3 determines a target key K1 on the first soft keyboard J1 corresponding to the touch operation according to the mapping relationship between the touch operations and the keys on the soft keyboard, and further triggers a key value corresponding to the target key K1 on the first soft keyboard J1. When a touch operation is input on the second touch area 22, the processor 3 determines a target key K2 on the second soft keyboard J2 corresponding to the touch operation according to the mapping relationship between the touch operations and the keys on the soft keyboard, and triggers a key value corresponding to the target key K2 on the second soft keyboard J2. Wherein, the touch area in which the touch operation is input of the present disclosure refers to a position where the user inputs the touch operation.

Therefore, the user can trigger the corresponding key by inputting the touch operation, which facilitates the user's input when the head mounted display device 100 is worn. In addition, the user can operate different soft keyboards of the soft keyboard input interface T1 in different touch areas, which increases the variety of operations.

In some embodiments, the keys K1 of the first soft keyboard J1 has the same layout as the keys K2 of the second soft keyboard J2. The layouts of the first soft keyboard J1 and the second soft keyboard J2 are both preset layouts. The mapping relationship between the touch operations and the keys on the soft keyboard includes a mapping relationship between a plurality of touch operations and different keys of the soft keyboard under the preset layout. Therefore, the mapping relationship between the touch operations and the keys on the soft keyboard also applies to the first soft keyboard J1 and the second soft keyboard J2. When the touch operation is input on the first touch area 21 or the second touch area 21, the processor 3 determines the target key on the first soft keyboard J1 or on the second soft keyboard J2 corresponding to the touch operation according to the mapping relationship between the touch operations and the keys on the soft keyboard, and further triggers the key value corresponding to the target key.

In some embodiments, the relative positions of the first touch area 21 and the second touch area 22 on the touch input apparatus 2 and the relative positions of the first soft keyboard J1 and the second soft keyboard J2 on the soft keyboard input interface T1 are the same. For example, as shown in FIG. 3 and FIG. 4, the first touch area 21 is located on a left side of the touch input apparatus 2, and the second touch area 22 is located on a right side of the touch input apparatus 2; the first soft keyboard J1 is located on a left side of the soft keyboard input interface T1, and the second soft keyboard J2 is located on a right side of the soft keyboard input interface T1.

The first soft keyboard J1 includes a key matrix J11 including N*M keys K1; the second soft keyboard J2 includes a key matrix J21 including N*M keys K2. That is, the key matrix J11 includes N rows and M columns of keys K1, and the key matrix J21 includes N rows and M columns of keys K2. Where, N and M are natural numbers and greater than 1.

In the drawings of the present disclosure, the description is made by taking N and M are both 3 as an example, that is, the key matrix J11 and the key matrix J21 are both 3*3 key matrix.

The soft keyboard input interface T1 can be in a digital input mode, an English input mode, or a Chinese pinyin input mode. After responding to the content input request, the processor 3 first determines an input mode of the soft keyboard input interface T1 to be displayed, and then controls a soft keyboard input interface T1 corresponding to the determined input mode to be displayed.

In some embodiments, the processor 3 determines that the input mode when the input is last exited is the input mode in which the soft keyboard input interface T1 is to be displayed, or the processor 3 determines the input mode of the soft keyboard input interface T1 according to a default input mode according to the user.

When the soft keyboard input interface T1 is in the different input mode, the key values of the keys K1 included in the first soft keyboard J1 on the soft keyboard input interface T1 and the key values of the keys K2 included in the second soft keyboard J2 on the soft keyboard input interface T1 are different.

The keys K1 on the first soft keyboard J1 are the main keys of the soft keyboard input interface T1 under the currently input mode. The keys K2 on the second soft keyboard J2 include at least one of additional keys of keys K1 on the first soft keyboard J1, function keys for triggering the first soft keyboard J1 to change key values, and next level keys of the triggered keys K1 on the first soft keyboard J1.

The key values for the target keys are triggered, includes: triggering input of a single character when the key value of the target key is a single character; and triggering multiple characters to be in a candidate state when the key values of the keys include multiple characters; triggering the keys to perform corresponding functions when the keys are function keys, that is, the key values of the keys are certain function icons.

For example, as shown in FIG. 3, when the soft keyboard input interface T1 is in the digital input mode, the key matrix J11 on the first soft keyboard J1 includes main keys which include numeric keys, for example, including: numeric keys 1-9 and the like. The key matrix J21 on the second soft keyboard J2 includes additional keys having specific character key values and/or function keys having specific function icons except the numeric keys. For example, the key matrix J21 on the second soft keyboard J2 includes additional keys such as “!” and “#”, and also includes function keys, such as, an emoticon icon key, a symbol key, and a Chinese/English switching key (key K2 of the second soft keyboard J2 having Chinese/English switching function icon as shown in FIG. 3), a delete key, an enter key, and the like.

When there is a touch operation input on the first touch area 21, the processor 3 determines a numeric key on the first soft keyboard J1 corresponding to the touch operation according to the mapping relationship between the touch operations and the keys on the soft keyboard, and triggers to input the key value of the numeric key, and further highlights the numeric key. For example, as shown in FIG. 3, when the numeric key corresponding to the touch operation is 1, the numeric key 1 is triggered to input.

When the touch operation is input on the second touch area 22, the processor 3 further determines the additional key on the second soft keyboard J2 corresponding to the touch operation according to the mapping relationship between the touch operations and the keys on the soft keyboard, and further triggers the key value of the corresponding additional key. For example, when the additional key corresponding to the touch operation is a Chinese/English switching key, the input mode of the soft keyboard input interface T1 is triggered to be changed to a Chinese pinyin input method or an English input method, and the key values of the keys K1 of first soft keyboard J1 are changed from the numeric key values to the Chinese pinyin alphabet key values or the English alphabet key values.

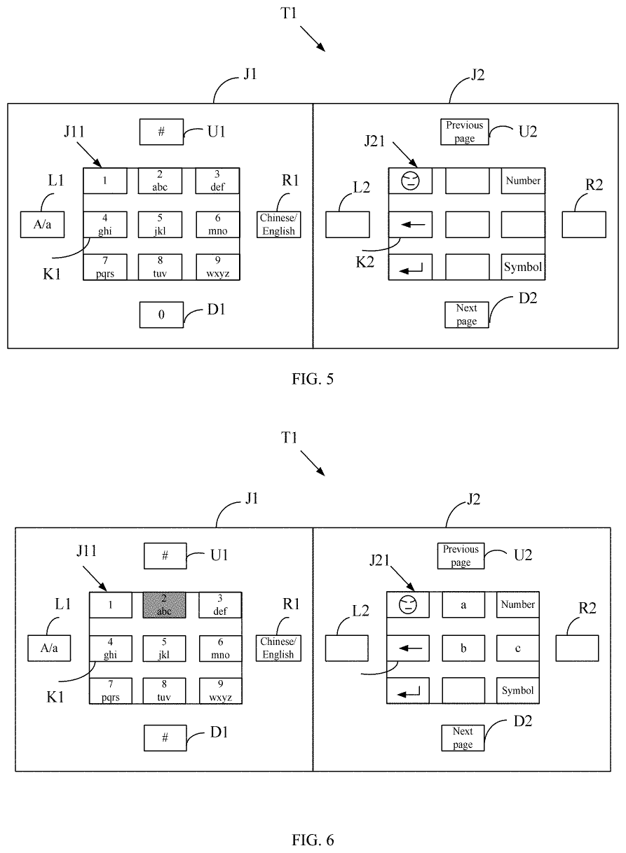

Please referring to FIG. 5 and FIG. 6 together, a schematic diagram of the soft keyboard input interface T1 in the English input mode is illustrated. As shown in FIG. 5, when the soft keyboard input interface T1 is in the English input mode and the user does not input a touch operation, the key matrix J11 on the first soft keyboard J1 includes a plurality of main keys such as keys K1 having English alphabet key values. Wherein, as shown in FIG. 5, each of the plurality of keys K1 having English alphabet key values respectively includes a plurality of English alphabet key values. In some embodiments, each of the plurality of keys K1 having English alphabet key values includes only one English alphabet key value, for example, an English full keyboard. The key matrix J21 of the second soft keyboard J2 includes a plurality of keys K2 having blank key values, additional keys having specific character key values, and/or function keys having specific function icons, such as emoticon icon keys, symbol keys, digital switching keys (keys K2 in the second soft keyboard J2 in which the “digital” function icon is displayed in FIG. 5), a delete key, an enter key, and the like.

In some embodiments, after a key value corresponding to the target key K1 on the first soft keyboard J1 or a key value corresponding to the target key K2 on the second soft keyboard J2 is triggered, the processor 3 controls the key value of the key K1 of the soft keyboard J1 and/or the key value of the key K2 of the second soft keyboard J2 to be changed.

As shown in FIG. 6, when a touch operation is input on the first touch area 21, the processor 3 determines the key corresponding to the touch operation is a certain key K1 having a plurality of English alphabet key values on the first soft keyboard J1 according to the mapping relationship between the touch operations and the keys on the soft keyboard, and triggers the corresponding key K1 to be in a candidate state, and further controls a plurality of keys K2 having blank key values on the second soft keyboard J2 to respectively display a plurality of English alphabet key values included in the key K1. For example, when the key corresponding to the touch operation is the abc English alphabet key of the first soft keyboard J1, that is, the key K1 including the abc three English alphabet key values, the processor 3 triggers the abc English alphabet key to be in the candidate state. The processor 3 further controls the plurality of keys K2 originally having blank key values on the second soft keyboard J2 to respectively display each character of the abc English alphabet key, that is, the processor 3 control a plurality of keys K2 originally having blank key values to respectively change to be next level keys of the three key values a, b, and c of the abc English alphabet key.

Similarly, the processor 3 further responds to the touch operation input on the second touch area 22, and determines a corresponding key on the second soft keyboard J2 corresponding to the touch operation according to the mapping relationship between the touch operations and the keys on the soft keyboard; and further triggers the key value of the key to be input. For example, when the processor 3 determines that the key corresponding to the touch operation is a, the processor 3 controls the character “a” to be input.

In some embodiments, the first soft keyboard J1 of the soft keyboard input interface T1 further includes a plurality of additional keys K1 surrounding the key matrix J11. The second soft keyboard J2 also includes a plurality of additional keys K2 surrounding the key matrix J21. In some embodiments, the plurality of additional keys K1 of the first soft keyboard J1 include a left additional key L1, a right additional key R1, an upper additional key U1, and a lower additional key D1. The plurality of additional keys K2 of the second soft keyboard J2 include a left additional key L2, a right additional key R2, an upper additional key U2, and a lower additional key D2. Obviously, in other embodiments, the additional keys K1 of the first soft keyboard J1 and the additional keys K2 of the second soft keyboard J2 may include other numbers of additional keys. In this paper, only four additional keys are taken as examples for description.

The four additional keys K1 of the first soft keyboard J1 and the four additional keys K2 of the second soft keyboard J2 are configured to provide additional keys for input.

When the soft keyboard input interface T1 is in different input modes, key values displayed by the four additional keys K1 of the first soft keyboard J1 can be same or different; key values displayed by the four additional keys K2 of the second soft keyboard J2 can also be the same or different. For example, as shown in FIG. 3, in the digital input mode, the four additional keys K1 of the first soft keyboard J1 respectively display the number 0, the punctuation marks “,”, “.”, and “?”. As shown in FIG. 5, in the English input mode, the four additional keys K1 of the first soft keyboard J1 respectively display the number 0, a punctuation mark “#”, a caps lock key “A/a”, and a Chinese-English switching key “Chinese/English” and so on.

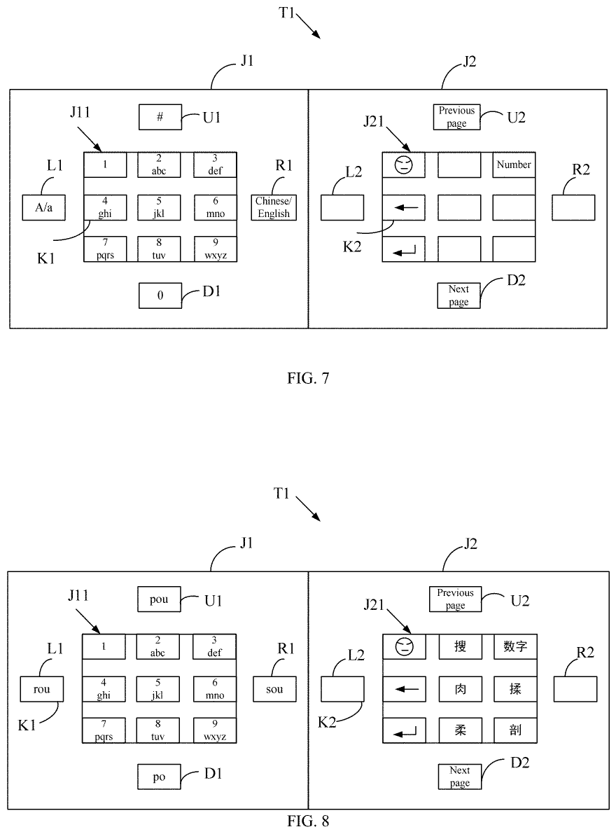

Please referring to FIGS. 7 to 9, a schematic diagram of an input process of the soft keyboard input interface T1 in a Chinese input mode is illustrated. As shown in FIG. 7, when the soft keyboard input interface T1 is in the Chinese input mode and the user does not input a touch operation, the key matrix J11 on the first soft keyboard J1 includes a plurality of keys K1 having Chinese alphabet key values, wherein, as shown in FIG. 7, each of the plurality of keys K1 having Chinese alphabet key values respectively includes a plurality of Chinese alphabet key values and a numeric key value. In other embodiments, each of the plurality of keys K1 having Chinese alphabet key values may include only one Chinese alphabet key value, for example, a Chinese full keyboard mode. The key matrix J21 of the second soft keyboard J2 includes a plurality of keys K2 having blank key values, additional keys having specific Chinese character key values, and/or function keys having specific function icons, such as a emoticon icon key, a symbol key, a digital switching key, a delete key, an enter key and other function keys.

The input of Chinese “ [symbol] ” is taken as an example for explanation. Since the pinyin of the “ [symbol] ” is rou, the three letters are respectively located on the keys K1 of which key values are 7, 6, and 8. The user can sequentially input the corresponding touch operations to sequentially trigger the several keys K1 including the 7, 6, and 8 key values.

As shown in FIG. 8, when a plurality of touch operations are sequentially input on the first touch area 21, the processor 3 determines a plurality of keys K1 respectively corresponding to the sequentially input touch operations according to the mapping relationship between the touch operations and the keys on the soft keyboard, and further determines at least one Chinese pinyin that can be obtained by sequentially combining the Chinese alphabet key values in the plurality of sequentially determined keys K1, and further displays the determined Chinese pinyin on the four additional keys K1 of the first soft keyboard J1. For example, as shown in FIG. 8, each of the four additional keys K1 respectively display Chinese pinyin rou, pou, sou, po. When the input intervals of the plurality of touch operations are less than a predetermined time interval (for example, 1 second), the processor 3 determines that the plurality of touch operations are a plurality of touch operations sequentially input.

The processor 3 controls a plurality of keys K2 having blank key values in the key matrix J21 of the second soft keyboard J2 to display the Chinese characters corresponding to the determined Chinese pinyin rou, pou, sou, po, for example, respectively displaying “ [symbol] ”, “ [symbol] ”, “ [symbol] ”, “ [symbol] ”, “ [symbol] ” and so on.

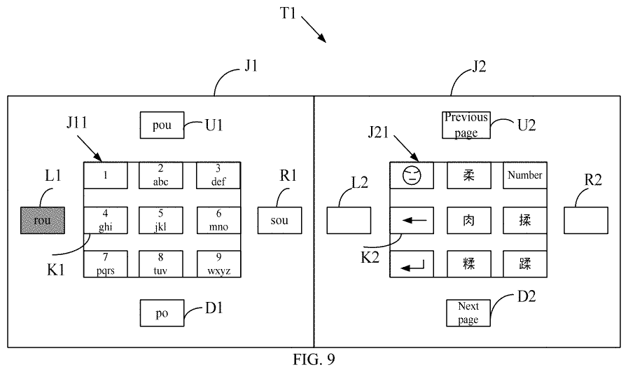

As shown in FIG. 9, when a touch operation is continued to input on the first touch area 21, and the key K1 corresponding to the touch operation is determined to be one of the additional keys, the processor 3 controls a plurality of keys K2 having blank key values of the key matrix J21 of the second soft keyboard J2 to be replaced with displaying of Chinese characters corresponding to the Chinese pinyin of the triggered additional key.

For example, as shown in FIG. 9, when the key K1 corresponding to the touch operation of is the left additional key L1, since the key value of the left additional key L1 is rou, the processor 3 controls a plurality of keys K2 having blank key values of the key matrix J21 of the second soft keyboard J2 to be replaced with displaying of “ [symbol] ” [symbol] “ [symbol] ” [symbol] “ [symbol] ” [symbol] “ [symbol] ” [symbol] “ [symbol] ” and the like.

The processor 3 responds to the touch operation input on the second touch area 22, and determines that the key K2 corresponding to the touch operation is a key for displaying “ [symbol] ”, and further controls the key for displaying “ [symbol] ” to be triggered to input the “ [symbol] ”.

For example, as shown in FIG. 8, if the “ [symbol] ” has been displayed in one key K2 of the second soft keyboard J2, the user can perform a corresponding touch operation through the second touch area 22 to trigger the key K2 displaying the “ [symbol] ”. And if the user wants to select the word “ [symbol] ”, but it does not appear in the second soft keyboard J2 as shown in FIG. 8. The user can continue to perform touch operation through the first touch area 21, trigger the left additional key L1 of which the key value is rou, so that the Chinese characters displayed by the second soft keyboard J2 are all corresponding to the pinyin rou. When the word “ [symbol] ” is displayed in the second soft keyboard J2, a corresponding touch operation can be performed on the second touch area 22, the key K2 displaying the word “ [symbol] ” is triggered to input the word “ [symbol] ”.

As shown in FIGS. 8 and 9, in the Chinese pinyin input mode, the four additional keys K2 in the second soft keyboard J2 further include keys for displaying the previous page and the next page, when the key corresponding to the touch operation input on the second touch area 22 is the key K2 of the previous page or the next page, the processor 3 controls the second soft keyboard J2 to replace and display other Chinese characters corresponding to the one or more keys K1 of Chinese pinyin determined or triggered on the current first soft keyboard J1.

In some embodiments, the processor 3 further controls the target key on the soft keyboard input interface T1 to be highlighted when the target key corresponding to the touch operation is determined. The highlighting may include highlighting, displaying in other colors, adding a special mark such as a circle, and the like. For example, as shown in FIG. 3, when the processor 3 determines that the key corresponding to the touch operation input on the first touch area 21 is the numeric key 1, further controls the digital key 1 to be highlighted. As shown in FIG. 6, when the processor 3 determines that the key corresponding to the touch operation input on the first touch area 21 is the abc English alphabet key, further controls the abc English alphabet key to be highlighted.

In some embodiments, when the soft keyboard input interface T1 is in a certain input mode, the first soft keyboard J1 and/or the second soft keyboard J2 include keys for switching to other input modes. When the key corresponding to the touch operation input on the first touch area 21 or the second soft keyboard J2 is the key for switching to another input mode, the processor 3 controls to switch to another input mode

For example, as shown in FIGS. 5 to 7, when the first soft keyboard J1 is in the initial interface of the Chinese pinyin input mode or the English input mode, the four additional keys K1 further include a caps lock key and a Chinese-English switching key, for example, the left additional key L1 corresponds to the caps lock key, and the right additional key R1 corresponds to the Chinese-English switching key. The processor 3 controls the case of the letters displayed by the first soft keyboard J1 to be changed when the key corresponding to the touch operation input on the first touch area 21 is determined to be the caps lock key. When the processor 3 determines that the key corresponding to the touch operation input on the first touch area 21 is the Chinese-English switching key, the processor 3 switches to another input mode according to the input mode of the current soft keyboard input interface T1. For example, when the input mode of the current soft keyboard input interface T1 is the Chinese input mode, and the key corresponding to the touch operation input on the first touch area 21 is the Chinese-English switch key, the processor 3 switches to the English input mode.

In addition, as described above, in the digital input mode, there is one key K2 in the key matrix J2 of the second soft keyboard J2 which is the Chinese-English switching key, and in the Chinese input mode or the English input mode, there is one key K2 in the key matrix J2 of the second soft keyboard J2 which is the digital switching key. When the soft keyboard input interface T1 is in the digital input mode, the processor 3 may also control the soft keyboard input interface T1 to switch to the Chinese input mode or the English input mode when the touch operation input on the second touch area 22 is determined to be the Chinese-English switching key. When the soft keyboard input interface T1 is in the Chinese input mode or the English input mode, the processor 3 may also control the soft keyboard input interface T1 to switch to the digital input mode when the key corresponding to the touch operation input on the second touch area 22 is the digital switching key.

In some embodiments, when the soft keyboard input interface T1 is in the digital input mode, and the key corresponding to the touch operation input on the second touch area 22 is determined to be the Chinese-English switching key, the processor 3 controls the soft keyboard input interface T1 to randomly enter one of the Chinese input mode and the English input mode. In another embodiment, the processor 3 determines whether the input mode before the digital input mode is the Chinese input mode or the English input mode. When the soft keyboard input interface T1 is in the digital input mode, and the key corresponding to the touch operation input on the second touch area 22 is the Chinese-English switching key, the processor 3 controls the second touch area 22 to enter the input mode before the digital input mode.

As shown in FIGS. 6 to 9 and the like, the second soft keyboard J2 further includes keys K2 having blank key values, which can be defined by the user to give key values, or be changed to be the keys with key values according to the operations input on the first soft keyboard J2, for example, as shown in FIGS. 6 to 9, the left additional key L2 and the right additional key R2 are reserved keys with blank key values, and the user can customize with the key values and the like.

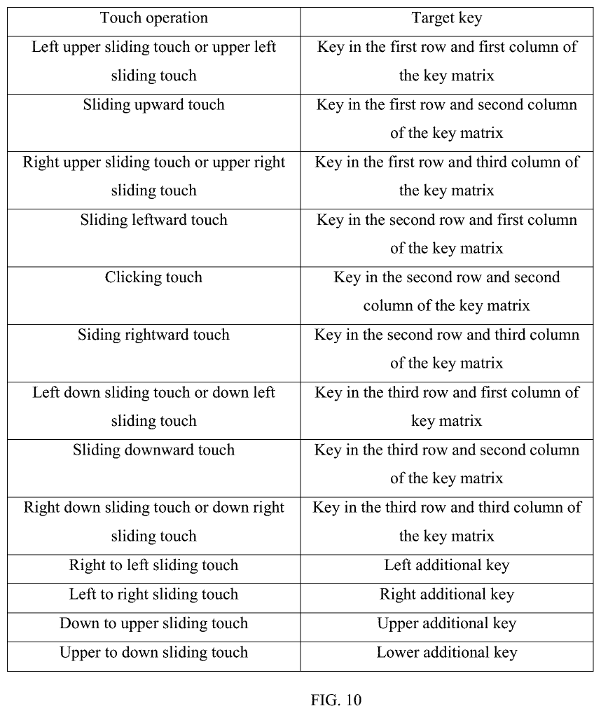

Please referring to FIG. 10, a schematic diagram of the mapping relationship between the touch operations and the keys on the soft keyboard is illustrated. In some embodiments, the mapping relationship between the touch operations and the keys on the soft keyboard is a mapping relationship table. The mapping relationship table defines a mapping relationship between a plurality of touch operations and a plurality of keys on the soft keyboard. The mapping relationship table is applicable to both the first soft keyboard J1 and the second soft keyboard J2.

In the present disclosure, the first soft keyboard J1 and the second soft keyboard J2 each having a layout including a 3*3 key matrix and four additional keys are taken as examples. As shown in FIG. 10, the mapping relationship between the plurality of touch operations and the keys on the soft keyboard includes: a mapping relationship between a left upper sliding touch or an upper left sliding touch and a key in the first row and first column of the key matrix; a mapping relationship between a sliding upward touch and a key in the first row and second column of the key matrix; a mapping relationship between a right upper sliding touch or an upper right sliding touch and a key in the first row and third column of the key matrix; a mapping relationship between a sliding leftward touch and a key in the second row and first column of the key matrix; a mapping relationship between a clicking touch and a key in the second row and second column of the key matrix; a mapping relationship between a sliding rightward touch and a key in the second row and third column of the key matrix; a mapping relationship between a left down sliding touch or a down left sliding touch and a key in the third row and first column of key matrix; a mapping relationship between a sliding downward touch and a key in the third row and second column of the key matrix; a mapping relationship between a right down sliding touch or a down right sliding touch and a key in the third row and third column of the key matrix; a mapping relationship between a right to left sliding touch and a left additional key; a mapping relationship between a left to right sliding touch and a right additional key; a mapping relationship between a down to upper sliding touch and an upper additional key; and a mapping relationship between an upper to down sliding touch and a lower additional key.

The left upper sliding touch, the upper left sliding touch, the right upper sliding touch, the upper right sliding touch, the upper to down sliding touch and the like mean that the touch operation is composed of sliding touches in two directions that are successively performed. For example, the left upper sliding touch refers to a touch operation of first sliding to the left and then sliding upward; the upper left sliding touch refers to a touch operation of first sliding upward and then sliding leftward; the right upper sliding touch refers to a touch operation of first sliding rightward and then sliding upward; the upper right sliding touch refers to a touch operation of first sliding upward and then sliding rightward; the upper to down sliding touch refers to a touch operation of first sliding upward and then sliding downward.

When a touch operation is input on the first touch area 21, the processor 3 determines a target key K1 on the first soft keyboard J1 corresponding to the touch operation according to the mapping relationship between touch operations and keys on the soft keyboard, and triggers a key value corresponding to the target key K1 on the first soft keyboard J1. When a touch operation is input on the second touch area 22, the processor 3 determines a target key K2 on the second soft keyboard J2 corresponding to the touch operation according to the mapping relationship between touch operations and keys on the soft keyboard, and triggers a key value corresponding to the target key K2 on the second soft keyboard J2.

Specifically, when the touch operation input on the first touch area 21 or the second touch area 22 is the left upper sliding touch or the upper left sliding touch, the processor 3 determines that the target key is the key in the first row and first column of the key matrix on the first soft keyboard J1 or the second soft keyboard J2. When the touch operation input on the first touch area 21 or the second touch area 22 is the sliding upward touch, the processor 3 determines that the target key is the key in the first row and second column of the key matrix on the first soft keyboard J1 or the second soft keyboard J2. When the touch operation input on the first touch area 21 or the second touch area 22 is the right upper sliding touch or the upper right sliding touch, the processor 3 determines that the target key is the key in the first row and third column of the key matrix on the first soft keyboard J1 or the second soft keyboard J2. When the touch operation input on the first touch area 21 or the second touch area 22 is the sliding leftward touch, the processor 3 determines that the target key is the key in the second row and first column of the key matrix on the first soft keyboard J1 or the second soft keyboard J2. When the touch operation input on the first touch area 21 or the second touch area 22 is the clicking touch, the processor 3 determines that the target key is the key in the second row and second column of the key matrix on the first soft keyboard J1 or the second soft keyboard J2. When the touch operation input on the first touch area 21 or the second touch area 22 is the sliding rightward touch, the processor 3 determines that the target key is the key in the second row and third column of the key matrix on the first soft keyboard J1 or the second soft keyboard J2. When the touch operation input on the first touch area 21 or the second touch area 22 is the left down sliding touch or the down left sliding touch, the processor 3 determines that the target key is the key in the third row and first column of the key matrix on the first soft keyboard J1 or the second soft keyboard J2. When the touch operation input on the first touch area 21 or the second touch area 22 is the sliding downward touch, the processor 3 determines that the target key is the key in the third row and second column of the key matrix on the first soft keyboard J1 or the second soft keyboard J2. When the touch operation input on the first touch area 21 or the second touch area 22 is the right down sliding touch or the down right sliding touch, the processor 3 determines that the target key is the key in the third row and third column of key matrix on the first soft keyboard J1 or the second soft keyboard J2.

When the touch operation input on the first touch area 21 or the second touch area 22 is the right to left sliding touch, the processor 3 determines that the target key is the left additional key on the first soft keyboard J1 or the second soft keyboard J2. When the touch operation input on the first touch area 21 or the second touch area 22 is the left to right sliding touch, the processor 3 determines that the target key is the right additional key on the first soft keyboard J1 or the second soft keyboard J2. When the touch operation input on the first touch area 21 or the second touch area 22 is the down to upper sliding touch, the processor 3 determines that the target key is the upper additional key on the first soft keyboard J1 or the second soft keyboard J2. When the touch operation input on the first touch area 21 or the second touch area 22 is the upper to bottom sliding touch, the processor 3 determines that the target key is the lower additional key on the first soft keyboard J1 or the second soft keyboard J2.

As shown in FIG. 2, the head mounted display device 100 further includes a storage 4, and the mapping relationship between the touch operations and the keys on the soft keyboard is stored in the storage 4. In some embodiments, the processor 3 is further configured to change data in the mapping relationship table of the touch operations and the keys on the soft keyboard in response to a user's operation, for example, adding a mapping relationship of a touch operation and a soft keyboard key, deleting a mapping relationship of a touch operation and a soft keyboard key, changing a soft keyboard key corresponding to a touch operation, or changing a touch operation corresponding to a soft keyboard key, and the like.

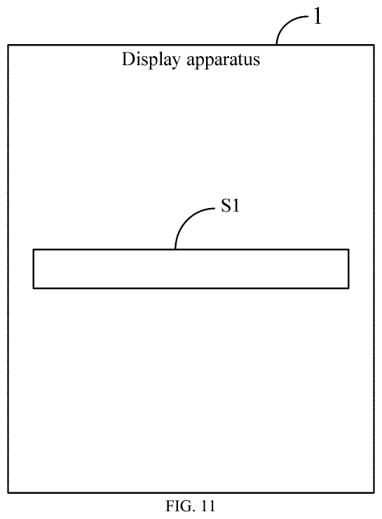

Referring to FIG. 11, the display apparatus 100 is further configured to display an input box S1. The input box S1 may be an input box of a certain application software or system software, and the content input request is generated after the user clicks on the input box S1. The application software may be a browser search toolbar, a short message input box, an audio and video player search bar, and the like.

The processor 3 is further configured to control the character to be displayed in the input box S1 when a key value of a key triggered by the soft keyboard input interface T1 is a character.

As shown in FIG. 1 or FIG. 2, the head mounted display device 100 further includes an earphone device 5 for outputting sound. The earphone device 5 includes two earphone earpieces 52 and an earphone loop 51, and the two earphone earpieces 52 are connected by the earphone loop 51.

In some embodiments, the touch input apparatus 2 can be a touch panel, and the touch panel is logically divided into the first touch area 21 and the second touch area 22. In other embodiments, the first touch area 21 and the second touch area 22 of the touch input apparatus 2 are two physically independent touch panels. In other embodiments, the touch input apparatus 2 can be a portable device with a touch screen, for example, a portable device such as a mobile phone or a tablet with a touch screen, and the first touch area 21 and the second touch area 22 are the two logically separated touch areas of the portable device.

The first touch area 21 and the second touch area 22 correspond to different touch point coordinate sets. The touch input apparatus 2 is coupled to the processor 3, and the touch input apparatus 2 generates a touch sensing signal when there is a touch operation input, and the touch sensing signal includes coordinate information of a plurality of touch points touched by the touch operation. The processor 3 receives the touch sensing signal, determines a touch point coordinate set to which the coordinates of the touch point belong according to coordinate information in the touch sensing signal, and determines a touch area in which the touch operation is located, and the processor 3 determines the corresponding touch operation according to the coordinate change of the touch point.

The processor 3 can be a processing chip such as a central processor, a microcontroller, a micro processor, a single chip microcomputer, or a digital signal processor.

The processor 3 may be located in the earphone apparatus 1 or in the display apparatus 1.

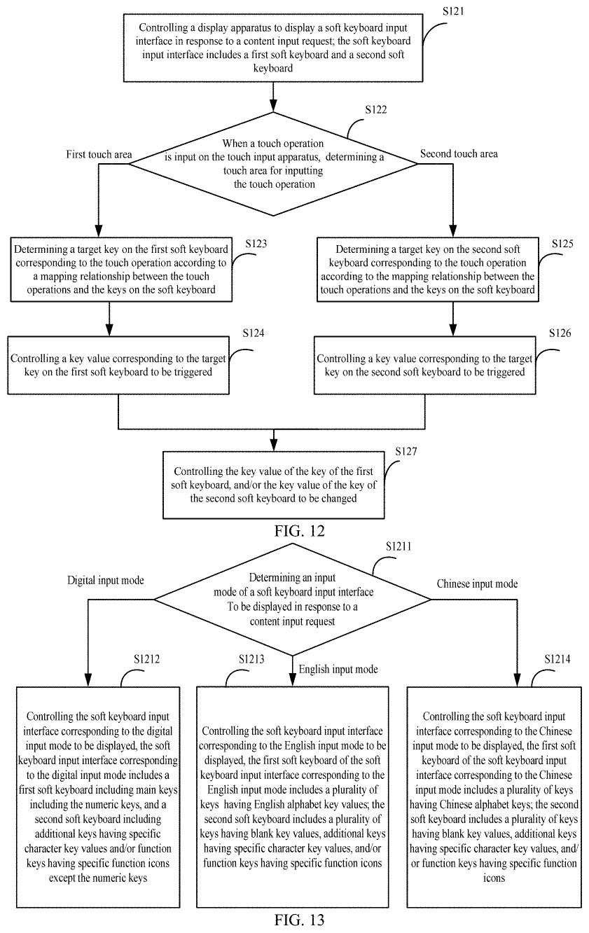

Please referring to FIG. 12, which is a flowchart of a content input method according to one embodiment of the present disclosure. The method is applied to the aforementioned head mounted display device 100. The method includes the steps of:

The processor 3 controls the display apparatus 1 to display a soft keyboard input interface T1 in response to a content input request. The soft keyboard input interface T1 includes a first soft keyboard J1 and a second soft keyboard J2 (S121). In one embodiment, the content input request is generated by clicking on an input box S1. The key K1 on the first soft keyboard J2 includes main keys in an input mode which the soft keyboard input interface T1 is currently in, and the key K2 on the second soft keyboard J2 includes at least one of additional keys of keys K1 on the first soft keyboard J1, function keys for triggering the first soft keyboard J1 to change key values, and next level keys of the triggered key K1 on the first soft keyboard J1.

When a touch operation is input on the touch input apparatus 2, the processor 3 determines that the touch area for inputting the touch operation (S122). The first touch area 21 and the second touch area 22 correspond to different touch point coordinate sets. The touch input apparatus 2 generates a touch sensing signal when the touch operation input is performed, and the touch sensing signal includes coordinate information of multiple touch points contacted by the touch operation. The step S122 includes: determining a touch point coordinate set to which the coordinates of the touch point belong according to the coordinate information in the received touch sensing signal, and determining a touch area in which the touch operation is located.

When the touch operation is input on the first touch area 21 of the touch input apparatus 2 of the head mounted display device 100, the processor 3 determines the target key K1 on the first soft keyboard J1 corresponding to the touch operation according to the mapping relationship between the touch operations and the keys on the soft keyboard (S123).

The processor 3 controls a key value corresponding to the target key K1 on the first soft keyboard J1 to be triggered (S124).

When the touch operation is input on the second touch area 22, the processor 3 determines the target key K2 on the second soft keyboard J2 corresponding to the touch operation according to the mapping relationship between the touch operations and the keys on the soft keyboard (S125)).

The processor 3 controls a key value corresponding to the target key K2 on the second soft keyboard J2 to be triggered (S126).

In some embodiments, the content input method further includes the steps of:

After the key value corresponding to the target key K1 on the first soft keyboard J1 or the key value corresponding to the target key K2 on the second soft keyboard J2 is triggered, the processor 3 controls the key value of the key K1 of the first soft keyboard J1 to be changed, and/or the key value of the key K2 of the second soft keyboard J2 to be changed (S127).

In some embodiments, the layouts of the keys of the first soft keyboard J1 and the second soft keyboard J2 are both preset layouts, and the mapping relationship between the touch operations and the keys on the soft keyboard includes a mapping relationship between a plurality of touch operations and a plurality of different keys of the soft keyboard under the preset layout. The first soft keyboard J1 and the second soft keyboard J2 each include a key matrix and a plurality of additional keys, and the steps S123 and S125 specifically determine the target key corresponding to the current touch operation is a key or an additional key in the key matrix by using a manner described previously with reference to the mapping relationship table described in FIG. 10.

Please referring to FIG. 13, which is a sub-flowchart of step S121. In some embodiments, the step S121 includes:

The processor 3 determines an input mode of a soft keyboard input interface T1 to be displayed in response to a content input request (S1211). In some embodiments, the processor 3 determines that the input mode in which the soft keyboard input interface T1 was last exited is the input mode of the soft keyboard input interface T1 to be displayed. In other embodiments, the processor 3 determines a default input mode preset by the user to be the input mode of the interface T1 of the soft keyboard to be displayed.

When the input mode is the digital input mode, the processor 3 controls the soft keyboard input interface T1 corresponding to the digital input mode to be displayed, wherein the soft keyboard input interface T1 corresponding to the digital input mode includes the first soft keyboard J1 and the second soft keyboard J2. The first keyboard J1 includes main keys. The main keys include the numeric keys. The second soft keyboard J2 includes additional keys having specific character key values and/or function keys having specific function icons except the numeric keys (S1212).

When the input mode is the English input mode, the processor 3 controls the soft keyboard input interface T1 corresponding to the English input mode to be displayed, wherein the first soft keyboard J1 of the soft keyboard input interface T1 corresponding to the English input mode includes a plurality of keys K1 having English alphabet key values, the second soft keyboard J2 includes a plurality of keys K2 having blank key values, additional keys K2 having specific character key values, and/or function keys K2 having specific function icons (S1213).

When the input mode is the Chinese input mode, the processor 3 controls the soft keyboard input interface T1 corresponding to the Chinese input mode to be displayed, wherein the first soft keyboard J1 of the soft keyboard input interface T1 corresponding to the Chinese input mode includes a plurality of keys K1 having Chinese alphabet keys, and the second soft keyboard J2 includes a plurality of keys K2 having blank key values, additional keys K2 having specific character key values, and/or function keys K2 having specific function icons (S1214).).

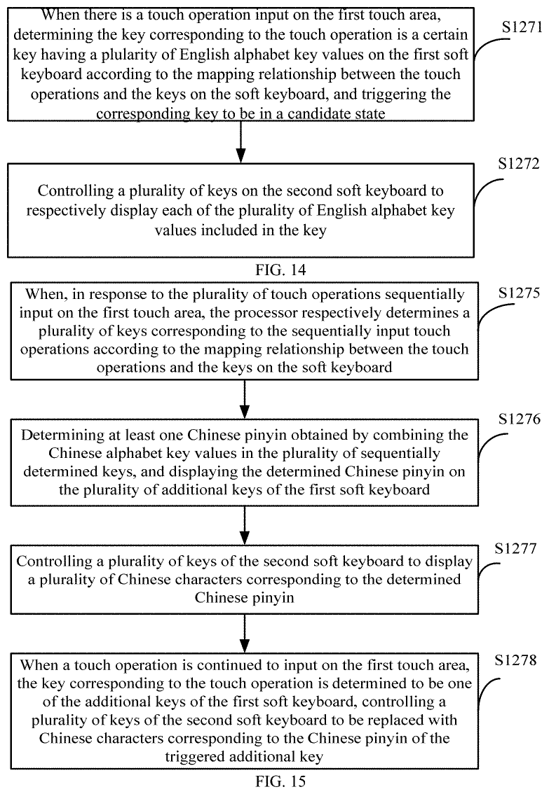

Please referring to FIG. 14, which is a sub-flowchart of step S127 in the first embodiment. In the first embodiment, the soft keyboard input interface T1 is in the English input mode, as shown in FIG. 14, the step S127 includes:

When there is a touch operation input on the first touch area 21, the processor 3 determines the key corresponding to the touch operation is a certain key having a plularity of English alphabet key values on the first soft keyboard J1 according to the mapping relationship between the touch operations and the keys on the soft keyboard, and triggers the corresponding key K1 to be in a candidate state (S1271).

The processor 3 controls a plurality of keys K2 on the second soft keyboard J2 to respectively display each of the plurality of English alphabet key values included in the key K1 (S1272). In some embodiments, a plurality of keys K2 having blank key values in the second soft keyboard J2 are controlled to respectively display each of the plurality of English alphabet key values.

Please referring to FIG. 15, a sub-flowchart of step S127 in the second embodiment is illustrated. In the second embodiment, the soft keyboard input interface T1 is in the Chinese input mode, as shown in FIG. 15, the step S127 includes:

The processor 3 respectively determines a plurality of keys K1 corresponding to the sequentially input touch operations according to the mapping relationship between the touch operations and the keys on the soft keyboard in respond to the plurality of touch operations sequentially input on the first touch area 21 (S1275).

The processor 3 determines at least one Chinese pinyin that can be obtained by sequentially combining the Chinese alphabet key values in the plurality of sequentially determined keys K1, and displays the determined Chinese pinyin on the plurality of additional keys K1 of the first soft keyboard J1. (S1276).

The processor 3 controls a plurality of keys K2 of the second soft keyboard J2 to display a plurality of Chinese characters corresponding to the determined Chinese pinyin (S1277). In some embodiments, the processor 3 controls keys K2 having blank key values in the second soft keyboard J2 to display a plurality of Chinese characters corresponding to the determined Chinese pinyin.

When a touch operation is continued to input on the first touch area 21, the processor 3 determines that the key K1 corresponding to the touch operation is one of the additional keys of the first soft keyboard J1, and controls a plurality of keys K2 of the second soft keyboard J2 to replace to display Chinese characters corresponding to the Chinese pinyin displayed by the triggered additional key (S1278).

In some embodiments, the step S127 further includes: when the key corresponding to the touch operation input on the second touch area 22 is the key K2 of the previous page key value or the next page key value, the processor 3 controls the second soft keyboard J2 to display another Chinese characters corresponding to the one or more Chinese pinyin keys K1 determined or triggered on the current first soft keyboard J1.

Therefore, the head mounted display device and the content input method of the present disclosure can be conveniently input by the user after wearing the head mounted display device.

The above is a preferred embodiment of the present disclosure, and it should be noted that those skilled in the art can also make several improvements and retouchings without departing from the principles of the present disclosure is the scope of protection of the present disclosure.

What is claimed is:

1. A head mounted display device, comprising a display apparatus, a touch input apparatus and a processor, wherein,
the touch input apparatus is configured to detect touch operations;
the touch input apparatus comprises a first touch area and a second touch area;
the processor controls the display apparatus to display a soft keyboard input interface in response to a content input request; the soft keyboard input interface comprises a first soft keyboard and a second soft keyboard; the first soft keyboard and the second soft keyboard each comprises a plurality of keys; the first touch area corresponds to the first soft keyboard, and the second touch area corresponds to the second soft keyboard;
when a touch operation is input on the first touch area, the processor determines a target key on the first soft keyboard corresponding to the touch operation, according to a mapping relationship between touch operations and keys on the soft keyboard, and triggers a key value corresponding to the target key on the first soft keyboard;
when a touch operation is input on the second touch area, the processor determines a target key on the second soft keyboard corresponding to the touch operation according to a mapping relationship between touch operations and keys on the soft keyboard, and triggers a key value corresponding to the target key on the second soft keyboard.

2. The head mounted display device of claim 1, wherein, layouts of the keys of the first soft keyboard and the second soft keyboard are preset layouts, and the mapping relationship between touch operations and keys on the soft keyboard comprises a mapping relationship between a plurality of touch operations and different keys of the soft keyboard in the preset layout; when touch operation is input on the first touch area or on the second touch area, the processor determines the target key on the first soft keyboard or the second soft keyboard corresponding to the touch operation according to the mapping relationship between the touch operations and the keys on the soft keyboard, and further triggers the key value corresponding to the target key.

3. The head mounted display device according to claim 1 or claim 2, wherein, the first soft keyboard and the second soft keyboard both comprise a key matrix comprising N*M keys.

4. The head mounted display device according to claim 3, wherein, input modes of the soft keyboard input interface comprises a digital input mode, an English input mode or a Chinese pinyin input mode; the processor firstly determines an input mode of the soft keyboard input interface to be displayed, and then displays a predefined soft keyboard input interface corresponding to the determined input mode in respond to the content input request.

5. The head mounted display device according to claim 4, wherein, the keys on the first soft keyboard are main keys of the soft keyboard input interface which are in the input mode; the keys on the second soft keyboard comprise at least one of additional keys of the keys on the first soft keyboard, function keys for triggering the first soft keyboard to change key values, and next level keys of the triggered key on the first soft keyboard.

6. The head mounted display device according to claim 5, wherein, when the soft keyboard input interface is in the digital input mode, the key matrix on the first soft keyboard comprises main keys having numeric keys, the key matrix on the second soft keyboard comprises additional keys having specific character key value and/or function keys having specific function icons except the numeric keys.

7. The head mounted display device according to claim 5, wherein, when the soft keyboard input interface is in the English input mode and the user does not input a touch operation, the key matrix on the first soft keyboard comprises a plurality of keys having English alphabet key values; the key matrix of the second soft keyboard comprise a plurality of keys having blank key values, additional keys having specific character key values, and/or function keys having specific function icons.

8. The head mounted display device according to claim 7, wherein, when a touch operation is input on the first touch area, the processor determines the key corresponding to the touch operation is a key having a plurality of alphabet key values on the first soft keyboard according to the mapping relationship between touch operations and keys on the soft keyboard, triggers the determined key to be in a candidate state, and controls each of a plurality of blank key values on the second soft keyboard to respectively display one of the plurality of English alphabet key values comprised in the determined key.

9. The head mounted display device according to claim 5, wherein, both of the first soft keyboard and the second soft keyboard of the soft keyboard input interface further comprise a plurality of additional keys surrounding the key matrix, the plurality of additional keys of the first soft keyboard and the plurality of additional keys of the second soft keyboard are configured to provide additional keys for input.

10. The head mounted display device according to claim 9, wherein, when the soft keyboard input interface is in the Chinese input mode and the user does not input a touch operation, the first soft keyboard of the key matrix on the first soft keyboard comprises a plurality of keys having Chinese alphabet keys, the key matrix of the second soft keyboard comprises a plurality of keys having blank key values, additional keys having specific character key values, and/or function keys having specific function icons; in respond to a plurality of sequential touch operations input on the first touch area, the processor determines a plurality of keys corresponding to the touch operations respectively according to the mapping relationship between the touch operations and the keys on the soft keyboard, and determines at least one Chinese pinyin combined by Chinese alphabet key values in the sequentially determined keys, and further controls the determined Chinese pinyin to be displayed on the plurality of additional keys of the first soft keyboard, and the processor further controls the plurality of keys having blank key values in the key matrix of the second soft keyboard to display Chinese characters corresponding to determined Chinese pinyin.

11. The head mounted display device according to claim 10, wherein, when a touch operation is input on the first touch area, the processor further determines that the key corresponding to the touch operation is one of the additional keys of the first soft keyboard, then triggers the determined additional key, and controls a plurality of keys having blank key values in the key matrix of the second soft keyboard to be replaced with Chinese characters corresponding to the Chinese pinyin of the triggered additional key.

12. The head mounted display device according to claim 1, wherein, the touch input apparatus is a touch panel or a portable device having a touch screen, and the first touch area and the second touch area are the touch pads or the portable device having the touch screen which is logically divided into two areas, or the first touch area and the second touch area are two physically independent sub-touch panels of the touch pad.

13. A content input method, applied to a head mounted display device comprising a display apparatus and a touch input apparatus, and the touch input apparatus comprises a first touch area and a second touch area, wherein, the method comprises the steps of:
controlling the display apparatus to display a soft keyboard input interface in response to a content input request, wherein, the soft keyboard input interface comprises a first soft keyboard and a second soft keyboard, and the first soft keyboard and the second soft keyboard each comprises a plurality of keys;
when a touch operation is input on the first touch area, determining a target key on the first soft keyboard corresponding to the touch operation according to a mapping relationship between touch operations and keys on the soft keyboard; and
triggering a key value corresponding to the target key on the first soft keyboard;
when a touch operation is input on the second touch area, determining a target key on the second soft keyboard corresponding to the touch operation according to a mapping relationship between touch operations and keys on the soft keyboard; and
triggering a key value corresponding to the target key on the second soft keyboard.

14. The method according to claim 13, wherein, layouts of the keys of the first soft keyboard and the second soft keyboard are preset layouts, and the mapping relationship between touch operations and keys on the soft keyboard comprises a mapping relationship between a plurality of touch operations and different keys of the soft keyboard in the preset layout.

15. The method according to claim 13, wherein, input modes of the soft keyboard input interface comprises a digital input mode, an English input mode or a Chinese pinyin input mode, and the step “controlling the display apparatus to display a soft keyboard input interface in response to a content input request” comprises:
in response to the content input request, firstly determining an input mode of the soft keyboard input interface to be displayed, and then displaying a predefined soft keyboard input interface corresponding to the determined input mode.

16. The method according to claim 15, further comprises:
controlling keys on the first soft keyboard to be defined as main keys in the input mode which the soft keyboard input interface is currently in, and controlling keys on the second soft keyboard to be defined as at least one of additional keys each comprising a key value on the first soft keyboard, function keys for triggering the first soft keyboard to change key values, and next level keys of the triggered key on the first soft keyboard.

17. The method according to claim 16, further comprises:
when the soft keyboard input interface is in the digital input mode, controlling to display a soft keyboard input interface corresponding to the digital input mode wherein, the first soft keyboard comprised by the soft keyboard input interface corresponding to the digital input mode comprises main keys having numeric keys, the second soft keyboard comprises additional keys having specific character key value and/or function keys having specific function icons except the numeric keys;
when the soft keyboard input interface is in the English input mode, controlling to display a soft keyboard input interface corresponding to the English input mode; wherein, the first soft keyboard comprised by the soft keyboard input interface corresponding to the English input mode comprises a plurality of keys having English alphabet key values; the second soft keyboard comprises a plurality of keys having blank key values, additional keys having specific character key values, and/or function keys having specific function icons;
when the soft keyboard input interface is in the Chinese input mode, controlling to display a soft keyboard input interface corresponding to the Chinese input mode to be displayed; wherein, the first soft keyboard comprised by the soft keyboard input interface corresponding to Chinese input mode comprises a plurality of keys having Chinese alphabet keys; the second soft keyboard comprises a plurality of keys having blank key values, additional keys having specific character key values, and/or function keys having specific function icons.

18. The method according to claim 17, further comprising:
while triggering a key value corresponding to the target key on the first soft keyboard or on the second soft keyboard, controlling to change the key value of the key of the first soft keyboard and/or the second soft keyboard.

19. The method according to claim 18, wherein, the step of “while triggering a key value corresponding to the target key on the first soft keyboard or on the second soft keyboard, controlling to change the key value of the key of the first soft keyboard and/or the second soft keyboard” comprises:
when the soft keyboard input interface is in the English input mode and there is a touch operation input on the first touch area, determining the key corresponding to the touch operation is a key having a plurality of alphabet key values on the first soft keyboard according to the mapping relationship of the touch operations and the keys on the soft keyboard, and triggering the corresponding key to be in a candidate state;
controlling a plurality of keys on the second soft keyboard to respectively display each of the plurality of English alphabet key values comprised in the corresponding key.

20. The method according to claim 18, wherein, the first soft keyboard further comprises a plurality of additional keys surrounding the keyboard matrix, the step “while triggering a key value corresponding to the target key on the first soft keyboard or on the second soft keyboard, controlling to change the key value of the key of the first soft keyboard and/or the second soft keyboard” comprises:
when the soft keyboard input interface is in the Chinese input mode, in response to a plurality of touch operations sequentially input on the first touch area, determining a plurality of keys corresponding to the sequentially input touch operations according to the mapping relationship of the touch operations and the keys on the soft keyboard;
determining at least one Chinese pinyin obtained by combining the Chinese alphabet key values of the plurality of sequentially determined keys, and displaying the determined Chinese pinyin on the plurality of additional keys of the first soft keyboard;
controlling the plurality of keys of the second soft keyboard to respectively display a plurality of Chinese characters corresponding to the determined Chinese pinyin; and
when the touch operation is continuously input on the first touch area, and the key corresponding to the touch operation is determined to be one of the additional keys of the first soft keyboard, controlling the plurality of keys of the second soft keyboard to be replaced with Chinese characters corresponding to the Chinese pinyin of the triggered additional keys.
